(19) United States
(12) Patent Application Publication
(10) Pub. No.: US 2017/0316764 A1
(43) Pub. Date: Nov. 2, 2017

(54) STICK-ON GUITAR STAND

(71) Applicant: Dennis Gerard Snyder, West Hills, CA (US)

(72) Inventor: Dennis Gerard Snyder, West Hills, CA (US)

(21) Appl. No.: 15/582,269

(22) Filed: Apr. 28, 2017

Related U.S. Application Data
(60) Provisional application No. 62/329,483, filed on Apr. 29, 2016.

(51) Int. Cl. G10G 5/00; F16M 13/00

(52) U.S. Cl. CPC G10G 5/00; F16M 13/005

(57) ABSTRACT

A stick-on guitar stand is made from a rubberized material and designed to attach to the bottom edge of a guitar body where the same would rest on a floor or other horizontal surface. The inventive stand has a bottom substrate joined to a back substrate at a generally right angle to match the bottom edge of most styles of guitar bodies. The bottom substrate and back substrate are attached using a common adhesive for musical instruments. Protrusions or foot pads extend from the bottom of the guitar stand to provide increased friction against smoot or low-friction surfaces upon which the guitar is rested. The rest of the guitar can them be leaned against an elevated surface as a table, amp, or wall.

### RELATED APPLICATION

This application claims the benefit of U.S. Provisional Application No. 62/329,483, filed on Apr. 29, 2016.

### BACKGROUND OF THE INVENTION

The present invention is directed to an accessory for use with musical instruments, specifically guitars of various shapes and sizes. More particularly, the present invention is directed to a stick-on stabilization stand for a guitar.

Musical instruments such as guitars are very often cherished pieces of equipment that are desirably maintained to keep up their appearance and avoid unsightly marks or damage. In addition, certain types of guitars rely upon a degree of integrity or maintaining a certain shape in order to produce the desired musical notes. Accordingly, there is a need for such instruments to be stored in a safe and secure manner so as to avoid unwanted damage to the guitar.

Sometimes, guitars can be stored on hooks or other structures mounted to walls or other accessible surfaces. However, the use of such mounted hooks or structures is limited insofar as once they are attached to a wall or surface they cannot be easily moved in case the user is not nearby. The user is limited to storing the guitar in the place where the hook or structure is mounted.

Most often, guitars are stored on a stand that is separate from a wall or surface. The stand generally consists of a base to upon which to rest the bottom of the guitar and an elevated bracket against which to lean the neck of the guitar. While such stands are mobile and can be carried by the user to another location, the stands can be cumbersome and difficult to transport. For one, the user needs to remember to bring the stand when carrying the guitar. In addition, the stand generally will not fit in a case with the guitar, thus creating a separate device that the user needs to carry along with the guitar. Furthermore, the stand needs to be placed in a location that is accessible and convenient to the user.

If a user is not near a fixed hook or forgets to bring a stand with them, one option for resting a guitar is to lay it flat on a horizontal surface as a floor, table, or amp. Such a flat surface is often not available or not accessible to a user. Another option for resting a guitar is to place the bottom of the guitar on a flat surface and lean the neck at an angle against an elevated surface as a table, a bookshelf, a chair, or a wall. If a user can find such a position, the guitar is often precariously balanced in such leaning angle position because of the inherent curvature of the bottoms of most guitars. A guitar rested in such a way could easily fall over if bumped, the floor bounces (as a stage), or is otherwise subjected to vibrations.

Accordingly, there is a need for new form of guitar stand that allows a user to more reliably rest a guitar when not in use, where the stand is not fixed to use in a single location and that is easily and conveniently transportable with the guitar. The present invention fulfills these needs and provides other related advantages.

### SUMMARY OF THE INVENTION

The present invention is directed to a stick-on guitar stand. The stick-on guitar stand generally includes a bottom base substrate, a back base substrate, and two foot protrusions. The bottom base substrate has a flat attachment surface carrying a first adhesive layer. The back base substrate has a flat positioning surface carrying a second adhesive layer. The bottom base substrate and the back base substrate are joined along a common edge such that the flat attachment surface and flat positioning surface are oriented approximately perpendicular to each other. The two foot protrusions are disposed on the bottom base substrate generally opposite the flat attachment surface.

The bottom base substrate and the back base substrate are preferably made from a flexible silicone rubber or similarly durable, resilient material. The flat attachment surface is preferably configured for attachment to a bottom surface of a guitar proximate to a back surface of the guitar. Similarly, the flat positioning surface is preferably configured for positioning on a back surface of a guitar proximate to a bottom surface of the guitar.

The back base substrate preferably has a pair of flaps that are spaced a predetermined distance apart. In this embodiment, the flat positioning surface preferably has two separate flat positioning surfaces with one disposed on each of the pair of flaps. The pair of flaps are preferably configured to move closer together so as to create a curve in the bottom base substrate.

The bottom base substrate preferably comprises a relief cut-out approximately midway between the two foot protrusions. The relief cut-out is configured to accommodate a guitar peg on the bottom surface of the guitar.

The two foot protrusions preferably each comprise a plurality of ridges oriented away from the flat attachment surface. The ridges are designed to increase friction of the foot protrusions relative to surfaces on which the foot protrusions are placed.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective view of the stick-on guitar stand of the present invention;

FIG. 2 is a perspective view of the stick-on guitar stand of the present invention taken from the opposite angle of FIG. 1;

FIG. 3 is front view of the stick-on guitar stand of the present invention;

FIG. 4 is a rear view of the stick-on guitar stand of the present invention;

FIG. 5 is a bottom view of the stick-on guitar stand of the present invention;

FIG. 6 is a side view of the stick-on guitar stand of the present invention;

FIG. 7 is an environmental view of the stick-on guitar stand of the present invention positioned on the bottom rear edge of a guitar;

FIG. 8 is a side environmental view of the stick-on guitar stand of the present invention positioned on the bottom rear edge of a guitar;

FIG. 9 is an environmental view of the stick-on guitar stand of the present invention on the bottom rear edge of a guitar;

FIG. 10 is a side environmental view of the stick-on guitar stand of the present invention positions on the bottom rear edge of a guitar;

FIG. 11 is an environmental view of a method of using the stick-on guitar stand of the present invention by leaning a guitar against a table;

FIG. 12 is an environmental view of a method of using the stick-on guitar stand of the present invention by leaning a guitar against an amp; and

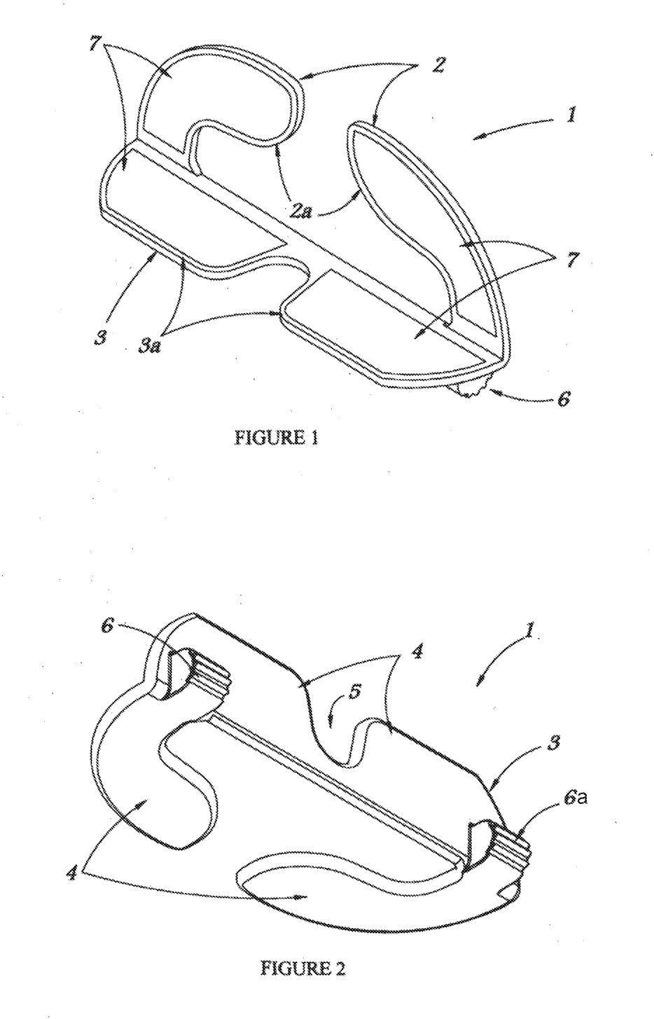

FIG. 1 3 is an environmental view of a method of using the stick-on guitar stand of the present invention by leaning a guitar against a wall.

### DETAILED DESCRIPTION OF THE PREFERRED EMBODIMENTS

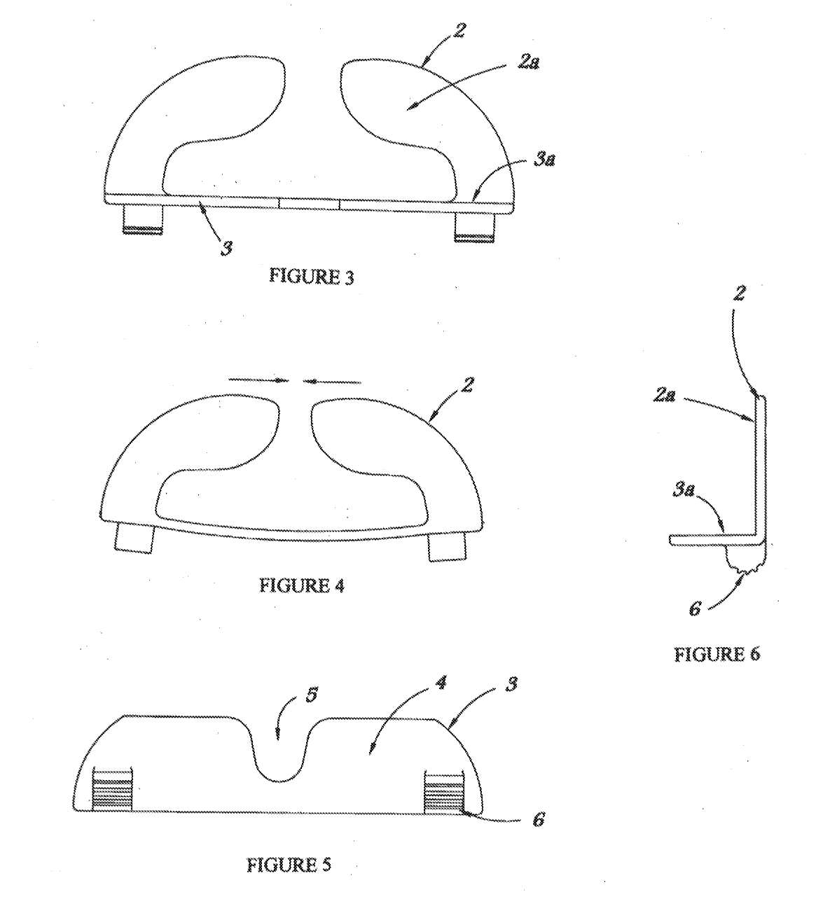

In the following detailed description, the stick-on guitar stand of the present invention is generally referred to by reference numeral 1 in FIGS. 1-13. The individual components and the structural relationship of the components of the inventive guitar stand 1 are most clearly shown in FIGS. 1 and 2. The use of “guitar” in this this description is intended to encompass other similar styles of stringed instruments having a similar bottom surface, including but not limited to guitar, bass, banjo, ukulele, lute, mandolin, sitar, oud, and others.

In FIGS. 1-6, the guitar stand 1 generally includes a bottom base substrate 3 and a back base substrate 2. The bottom base substrate 3 and back base substrate 2 are joined along a common edge 15 in a generally perpendicular relationship so as to form a generally right angle. The precise angle of the common edge 15 between the bottom base substrate 3 and the back base substrate 2 is variable because of the flexible nature of the stick-on guitar stand 1 as described more fully below.

The front side of the back base substrate 2 preferably includes a flat positioning surface 2a. The back base substrate 2 and flat positioning surface 2a may be contiguous (not shown). Preferably, the back base substrate 2 is separated into two distinct back base flap substrates 2 spaced a predetermined distance apart from each other. As shown by the arrows in FIG. 4, the two distinct back base flap substrates 2 may be moved closer together so as to create a curvature in the bottom base substrate 3. Such curvature may be necessary to allow the inventive guitar stand 1 to conform to the shape of the bottom surface 13 of a particular guitar body 9. Different guitar bodies 9 have different degrees of curvature to the bottom surface 13 and the inventive guitar stand 1 is designed to adapt to such different styles of guitars.

The front side of the bottom base substrate 3 preferably includes a flat attachment surface 3a. The flat attachment surface 3a may be a contiguous surface. Preferably, the bottom base substrate 3 is separated into two regions separated by a partial relief or cut-out 5. The two regions of the bottom base substrate 3 remain joined into a single part around the partial relief or cut-out 5. The partial relief or cut-out 5 also separates the flat attachment surface 3a into a plurality of surfaces 3a.

The back sides of the back base substrate 2 and bottom base substrate 3 preferably include flat surfaces 4. These flat surfaces 4 are provided for receiving markings, such as branding, notices, and other information that is commonly carried on similar types of accessories.

A pair of protrusions or foot pads 6 extends from the back side of the bottom base substrate 3. The protrusions or foot pads 6 are preferably proximate to the common edge 15 between the back base substrate 2 and the bottom base substrate 3. The protrusions or foot pads 6 preferably include a plurality of ridges 6a that are designed to provide the foot pads 6 with increased friction or traction on certain types of smooth or low-friction surfaces.

The protrusions or foot pads 6 are preferably spaced a distance apart sufficient to provide a stable base for most common guitar shapes and sizes. This distance is preferably in the range of approximately three inches to four inches. A person of ordinary skill in the art will understand that different distances can be used for larger or smaller guitars. This statement of approximate distances is only intended as a guideline and not necessarily intended to limit the scope of the invention.

The flat positioning surfaces 2a and flat attachment surfaces 3a carry an adhesive layer 7 for attaching the surfaces 2a, 3a to the respective bottom surface 13 and back surface 14 of a guitar body 9. Such adhesive layers 7 are preferably of a type to maintain a semi-permanent attachment, while permitting selective removal without damaging the finish on a guitar. A person or ordinary skill in the art will understand that similar adhesives are used on guitars as attaching a pick guard or similar features. The adhesive layers 7 may be provided with a removable cover (not shown) to protect the adhesive layers 7 until the stick-on guitar stand 1 is ready to be attached to a guitar.

All of the components on the inventive guitar stand 1, primarily including the back base substrate 2, bottom base substrate 3, and protrusions or foot pads 6, are preferable made from a flexible, resilient material that can be easily deformed or twisted without being damaged, and that also provides increased friction against smooth or low-friction surfaces. It has been determined that silicone rubber provides the described advantages, but it will be appreciated that other forms of rubber or similar materials may likely provide similar advantages.

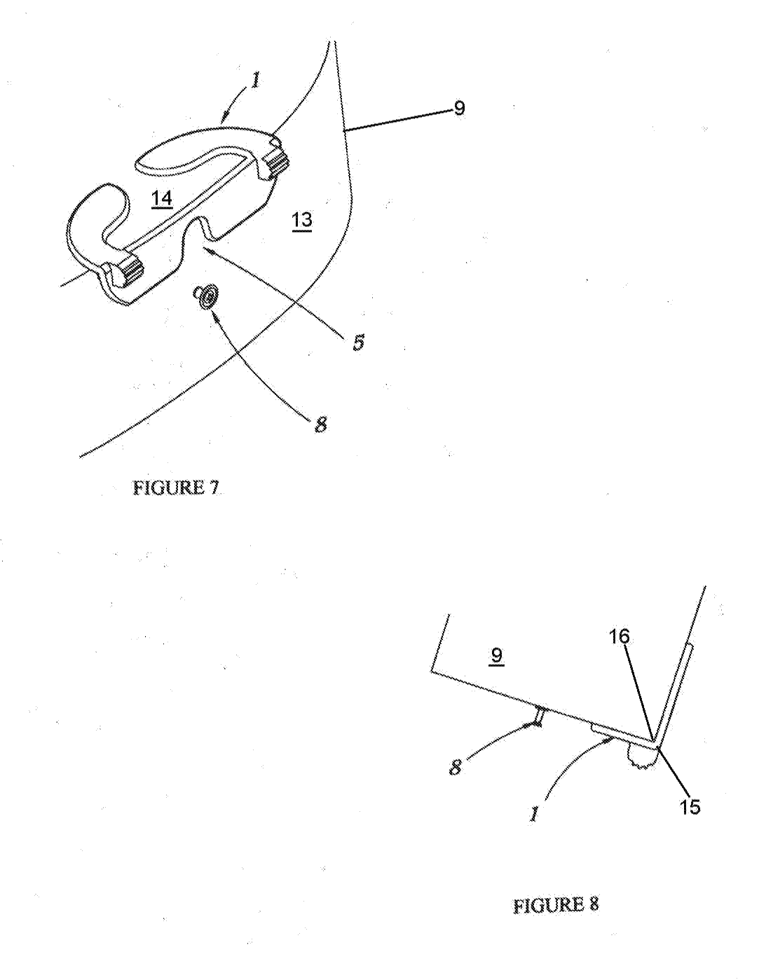

FIGS. 7 and 8 illustrate the use of the inventive guitar stand 1 on a typical guitar body 9, as an acoustic guitar. As shown, the bottom base substrate 3 is placed against the bottom surface 13 of the guitar body 9 and the back base substrate 2 is placed against the back surface 14 of the guitar body. The common edge 15 rests against the edge 16 joining the bottom surface 13 and back surface 14. The inventive guitar stand 1 is attached to the bottom surface 13 and back surface 14 of the guitar body 9 by exposure of the adhesive layers 7, which are placed against the respective surfaces 13, 14 as described. Depending upon the curvature of the bottom surface 13, the back base flap substrates 2 may be moved closer together to create an appropriate amount of curvature in the bottom base substrate 3.

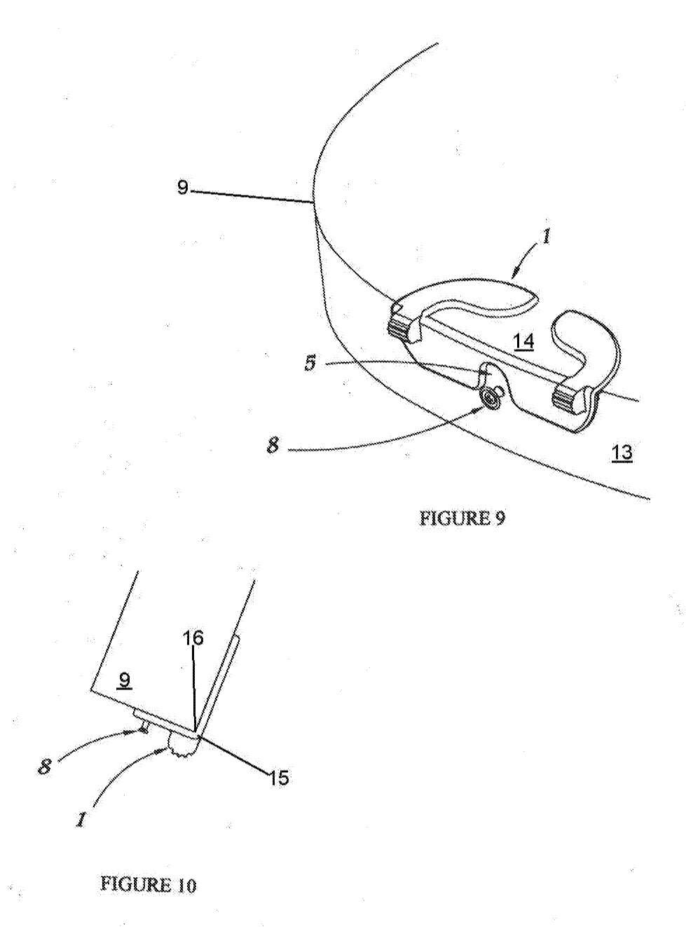

The relief or cut-out 5 in the bottom base substrate 3 is shown in relation to the guitar peg 8, but the two parts do not interact in this illustration due to the thickness of the acoustic guitar body 9. FIGS. 9 and 10 illustrate the use of the inventive guitar stand 1 on a different style of guitar body 9, as an electric guitar. The inventive guitar stand 1 is attached to the guitar body 9 in a similar manner as described in the illustration of FIGS. 7 and 8. In the present illustration, the relief or cut-out 5 accommodates the guitar peg 8 or similar structure as may be found on the bottom surface 13 of the guitar body 9.

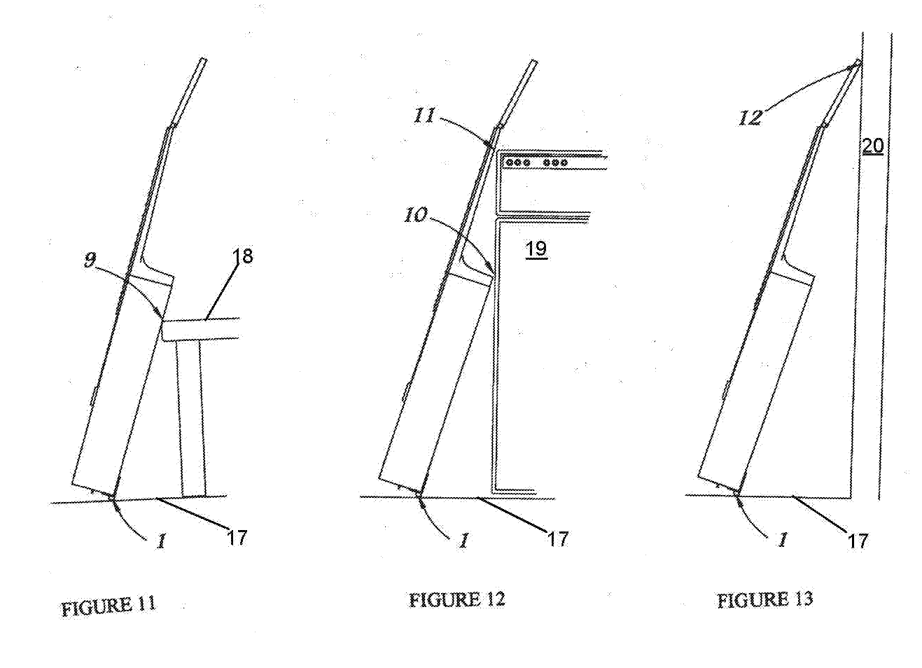

FIGS. 11-13 illustrate use of the inventive guitar stand 1 to lean a guitar body 9 against different surfaces. FIG. 11 shows a guitar body 9, including the inventive guitar stand 1, with the protrusions or foot pads 6 resting on the floor 17 and the guitar body 9 leaning against a table 18. FIG. 12 also shows a guitar body 9, including the inventive guitar stand 1, with the protrusions or foot pads 6 resting on the floor 17, but in this instance the heel 10 and/or neck 11 of the guitar are leaning against an amp 19. FIG. 13 also shows a guitar body 9, including the inventive guitar stand 1, with the protrusions or foot pads 6 resting on the floor 17 and the head 12 of the guitar leaning against a wall 20.

In any of these embodiments, the inventive guitar stand 1 provides a stable base for the guitar, so that a user can have more certainty that the guitar is likely to remain in its resting position leaning upright against a particular surface. The protrusions or foot pads 6 provide a wide base on the floor 17 so that the guitar is less likely to tip to either side. In addition, the protrusions or foot pads 6 provide increased friction against the floor 17 as opposed to the bare guitar edge 16 without the inventive guitar stand 1.

Once the inventive guitar stand 1 is attached to a guitar body 9, it should generally remain attached during most ordinary uses of the guitar. The guitar stand 1 has a low profile such that any guitar upon which it is installed will still fit in nearly any guitar case designed to accommodate the particular style of guitar. The protrusions or foot pads 6 generally do not protrude much beyond the guitar peg 8 or similar structures, it at all. A user that has attached an inventive guitar stand 1 to their instrument does not need to worry about forgetting their guitar stand when travelling with the guitar or otherwise finding a way to reliably rest their guitar on the floor while leaning against an elevated surface.

Although several embodiments have been described in detail for purposes of illustration, various modifications may be made without departing from the scope and spirit of the invention. Accordingly, the invention is not to be limited, except as by the appended claims.

What is claimed is:

1. A stick-on guitar stand, comprising
a bottom base substrate having a flat attachment surface carrying a first adhesive layer;
a back base substrate having a flat positioning surface carrying a second adhesive layer,
wherein the bottom base substrate and the back base substrate are joined along a common edge such that the flat attachment surface and flat positioning surface are oriented approximately perpendicular to each other; and
two foot protrusions disposed on the bottom base substrate generally opposite the flat attachment surface.

2. The stick-on guitar stand of claim 1, wherein the bottom base substrate and the back base substrate are made from a flexible silicone rubber.

3. The stick-on guitar stand of claim 1, wherein the flat attachment surface is configured for attachment to a bottom surface of a guitar proximate to a back surface of the guitar.

4. The stick-on guitar stand of claim 1, wherein the flat positioning surface is configured for positioning on a back surface of a guitar proximate to a bottom surface of the guitar.

5. The stick-on guitar stand of claim 1, wherein the back base substrate comprises a pair of flaps that are spaced a predetermined distance apart.

6. The stick-on guitar stand of claim 5, wherein the flat positioning surface comprises two separate flat positioning surfaces, one disposed on each of the pair of flaps.

7. The stick-on guitar stand of claim 5, wherein the pair of flaps are configured to move closer together so as to create a curve in the bottom base substrate.

8. The stick-on guitar stand of claim 1, wherein the bottom base substrate comprises a relief cut-out approximately midway between the two foot protrusions.

9. The stick-on guitar stand of claim 1, wherein the two foot protrusions each comprise a plurality of ridges oriented away from the flat attachment surface.
